(19) United States
(12) Patent Application Publication
(10) Pub. No.: US 2026/0097493 A1
(43) Pub. Date: Apr. 9, 2026

(54) SYSTEMS AND METHODS FOR A ROBOT KNEE JOINT ASSEMBLY

(71) Applicant: Tesla, Inc., Austin, TX (US)

(72) Inventor: Rod JAFARI, Austin, TX (US)

(73) Assignee: Tesla, Inc., Austin, TX (US)

(21) Appl. No.: 19/113,893

(22) PCT Filed: Oct. 2, 2023
(86) PCT No.: PCT/US2023/034300

§ 371 Date: Mar. 20, 2025

Related U.S. Application Data
(60) Provisional application No. 63/378,034, filed on Sep. 30, 2022.
(60) Provisional application No. 63/377,919, filed on Sep. 30, 2022.

(51) Int. Cl. B25J 9/16; B25J 13/08; B25J 17/00; B62D 57/032

(52) U.S. Cl. CPC B25J 9/1633; B25J 13/088; B25J 17/00; B62D 57/032

(57) ABSTRACT

Disclosed herein is a knee joint assembly including a first link member having a first end mechanically coupled to an upper leg of a robot and configured to rotate around a first pivot relative to the upper leg, and a second link member having a first end mechanically coupled to a lower leg of the robot. The lower leg can be mechanically coupled to the upper leg and configured to rotate around a second pivot relative to the upper leg. A linear actuator device can be mechanically coupled to a second end of the first link member and a second end of the second link member, and when actuated can cause the first link member to rotate around the first pivot relative to the upper leg of the robot and cause the leg to rotate around the second pivot relative to the upper leg.

### CROSS-REFERENCE TO RELATED PATENT APPLICATIONS

The present application claims priority to U.S. Provisional Application No. 63/377,919, filed Sep. 30, 2022, and claims priority to U.S. Provisional Application No. 63/378,034, filed Sep. 30, 2022, both applications are incorporated by reference in their entirety for all purposes.

### TECHNICAL FIELD

The present disclosure generally relates to systems and methods for robot joints. In particular, the current disclosure relates to systems and methods for a robot knee joint.

### BACKGROUND

A robot can be viewed as a chain or collection of joints, that enable desired motions of the robot. Each joint enables adjacent structures or elements to move relative to one another. The motion of the adjacent elements is driven by one or more actuators associated with the joint. A computer system controls the actuator(s) to achieve the desired motion(s).

The design of a joint defines the range of motion of the corresponding adjacent elements. Also, the joint design can affect the number and/or type(s) of actuators to be used as well as the efficiency of the actuator(s).

### SUMMARY

The reliability and efficiency of robots depend significantly on the adopted joint designs. A well-designed joint can enhance the range of motion of adjacent elements and reduce the amount of power consumed by the robot. In the current disclosure, systems, and methods for a knee joint assembly configured to mimic the knee joints of humans are described. In particular, the knee joint assembly described herein allows for a range of rotation of the lower part of a robot leg similar to the range of rotation seen in humans. Also, the knee joint assembly described herein can be driven by a single linear actuator and enables to minimize or reduce power usage, or maximize or increase efficiency, while still meeting torque, speed and range of motion.

According to at least one aspect, a system can comprise a knee joint assembly. The knee joint assembly can include a first link member having a first end mechanically coupled to an upper portion of a leg of a robot and configured to rotate around a first pivot relative to the upper portion of the leg of the robot; a second link member having a first end mechanically coupled to a lower portion of the leg of the robot, the lower portion of the leg of the robot mechanically coupled to the upper portion of the leg of the robot and configured to rotate around a second pivot relative to the upper portion of the robot, and a linear actuator device mechanically coupled to a second end of the first link member and a second end of the second link member, the linear actuator device, when actuated, causes the first link member to rotate around the first pivot relative to the upper portion of the leg of the robot and causes the lower portion of the leg of the robot to rotate around the second pivot relative to the upper portion of the leg of the robot.

The first link member can be configured to rotate around a third pivot relative to the linear actuator device and the second link member can be configured to rotate around a fourth pivot relative to the linear actuator device. In some implementations, the fourth pivot can be the same as the third pivot, and the third pivot can mechanically couple both the second end of the first link member and the second end of the second link member to the linear actuator device. In some implementations, the fourth pivot can be different from the third pivot, the third pivot can mechanically couple the second end of the first link member to the linear actuator device, and the fourth pivot can mechanically couple the second end of the second link member to the second end of the first link member.

The lower portion of the leg of the robot can be configured to rotate around a third pivot relative to the second link member, the third pivot mechanically coupling the first end of the second link member to the lower portion of the leg of the robot.

The linear actuator device can include a moving structure mechanically coupled to the second end of the first link member and configured to cause the second end of the first link member to move according to a translational motion, when the linear actuator device is actuated, causing the first link member to rotate around the first pivot relative to the upper portion of the leg of the robot. The linear actuator device can include a servo motor configured to cause the moving structure to move according to the translational motion.

The first link member can have a rotation angle range of about 60 degrees. In some implementations, the lower portion of the leg of the robot has a rotation angle range of about 150 degrees. In some implementations, the second link member includes a force sensor. In some implementations, the robot can be a humanoid robot.

The system can include a processing circuitry including a memory and a processor and configured to control the linear actuator device. The processing circuitry can be configured to determine a desired orientation of the lower portion of the leg of the robot relative to the upper portion of the leg of the robot; determine, using the desired orientation of the lower portion of the leg of the robot relative to the upper portion of the leg of the robot, a displacement of a moving structure of the linear actuator device; and send instructions to the linear actuator device to cause the moving structure to move by the determined displacement. In some implementations, the processing circuitry is configured to compute the displacement of the moving structure using an orientation of the lower portion of the leg of the robot, a speed of the lower portion of the leg of the robot and a desired torque.

According to at least one aspect, a method can comprise determining, by a processing circuitry, an orientation of a lower portion of a leg of a robot relative to an upper portion of the leg of the robot, the lower portion of the leg of the robot mechanically coupled to the upper portion of the leg of the robot and configured to rotate around a first pivot relative to the upper portion of the robot; determining, by the processing circuitry using the orientation of the lower portion of the leg of the robot relative to the upper portion of the leg of the robot, a displacement of a moving structure of a linear actuator device, the moving structure of the linear actuator device mechanically coupled to a first end of the first link member and a first end of the second link member; sending instructions to the linear actuator device to cause the moving structure to move by the determined displacement; and causing, by the linear actuator device, the moving structure to move by the determined displacement leading to a rotation of the lower portion of the leg of the robot relative to the upper portion of the leg of the robot to reach the desired orientation. The first link member can have a second end mechanically coupled to the upper portion of the leg of the robot and can be configured to rotate around a second pivot relative to the upper portion of the leg of the robot. The second link member can have a second end mechanically coupled to the lower portion of the leg of the robot.

Determining the displacement of the moving structure can include computing the displacement of the moving structure in real time using an instantaneous orientation of the lower portion of the leg of the robot, a speed of the lower portion of the leg of the robot and a desired torque.

The first link member can be configured to rotate around a third pivot relative to the moving structure of the linear actuator device and the second link member can be configured to rotate around a fourth pivot relative to the moving structure of the linear actuator device.

The fourth pivot can be the same as the third pivot, and the third pivot can mechanically couple both the second end of the first link member and the second end of the second link member to the linear actuator device; or the fourth pivot can be different from the third pivot, the third pivot can mechanically couple the second end of the first link member to the linear actuator device, and the fourth pivot can mechanically couple the second end of the second link member to the second end of the first link member.

The lower portion of the leg of the robot can be configured to rotate around a third pivot relative to the second link member, the third pivot can mechanically couple the first end of the second link member to the lower portion of the leg of the robot.

The first link member can have a rotation angle range of about 60 degrees. In some implementations, the lower portion of the leg of the robot can have a rotation angle range of about 150 degrees.

### BRIEF DESCRIPTION OF THE DRAWINGS

Non-limiting embodiments of the present disclosure are described by way of example concerning the accompanying figures, which are schematic and are not intended to be drawn to scale. Unless indicated as representing the background art, the figures represent aspects of the disclosure.

FIG. 1 illustrates a diagram of an example humanoid robot where systems and methods described herein can be integrated, according to an embodiment.

FIG. 2 illustrates diagrams depicting an analogy between the anatomy of the human knee joint and a high-level design of a knee joint for robots, according to an embodiment.

FIGS. 3A and 3B illustrate two views of both legs of a humanoid robot, according to an embodiment.

FIG. 4 illustrates an example knee joint assembly of the humanoid robot of FIG. 3, according to an embodiment.

FIG. 5 illustrates a flow chart depicting a method for operating or controlling the knee joint assembly of FIG. 4, according to an embodiment.

FIG. 6 depicts a graph showing simulation results for different candidate designs (e.g., with different parameters) of the knee joint assembly, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting to the subject matter presented.

The robot can be viewed as a collection of joints that are designed to enable the movement of one or more links or elements adjacent to each joint. The design, structure, and mechanisms of a joint can significantly affect the stability, reliability, and efficiency of the robot. For example, a poorly designed joint can result in poor geometry, an increased number of used actuators, an increase in power consumption by the robot, and/or a limited motion range of one or more components of the robot. In the current disclosure, a joint assembly that is designed or configured to mimic the knee joints of humans is described. In particular, the knee joint assembly described herein allows for a relatively wide range of rotation, e.g., about 150 degrees (e.g., between 140 and 160 degrees), of the lower leg of a robot. Such range is similar to the range of rotation seen in humans. Also, the joint assembly described herein can be driven by a single linear actuator with improved efficiency. Specifically, while the range of rotation of the robot's lower leg can be about or close to 150 degrees, the linear actuator is configured or structured to cause rotation of a link that has a smaller range of rotation, e.g., about 60 degrees. This implies that a relatively large angle of rotation of the lower leg can be achieved with a relatively small movement by the linear actuator, which allows for a compact design of the knee joint.

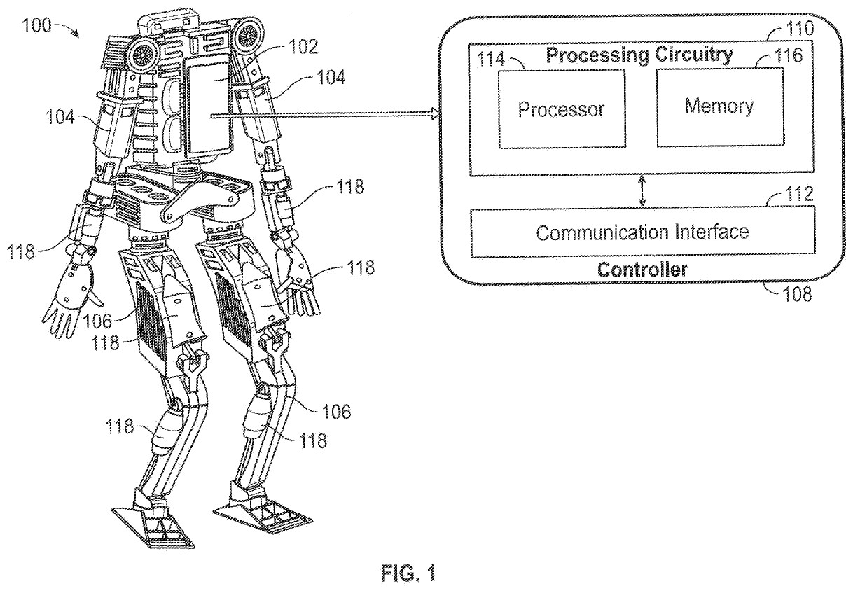

FIG. 1 is a diagram of an example humanoid robot 100 where the systems and methods described herein can be integrated, according to an example embodiment. The humanoid robot 100 can include an upper body 102, two arms 104, and two legs 106. The upper body 102 can include a controller 108 for controlling the robot 100. The controller 108 can include a processing circuitry 110 and a communication interface 112. The processing circuitry 110 can be communicatively coupled to the communication interface 112. The processing circuitry 110 can include a processor 114 and a memory 116. The robot 100 can include a plurality of actuators 118 associated with a plurality of joints. The robot 100 may include one or more sensors for sensing parameters of the robot 100 or the surroundings of robot 100. The robot 100 may include one or more cameras.

The processor 114 may be implemented as a single-or multi-chip processor, a digital signal processor (DSP), an application-specific integrated circuit (ASIC), a field programmable gate array (FPGA), or other programmable logic device, discrete gate or transistor logic, discrete hardware components, or any combination thereof designed to perform the functions described herein. The processor 114 may be a microprocessor. The processor 114 also may be implemented as a combination of computing devices, such as a combination of a DSP and a microprocessor, a plurality of microprocessors, one or more microprocessors in conjunction with a DSP core, or any other such configuration. In some implementations, the controller 108 may include one or more processors 114.

The memory 116 (e.g., memory unit and/or storage device) may include one or more devices (e.g., RAM, ROM, Flash memory, hard disk storage) for storing data and/or computer code for completing or facilitating the various processes described in the present disclosure. The memory 116 may be communicably connected to the processor 114 to provide computer code or instructions to the processor 114 for executing at least some of the processes described herein. Moreover, the memory 116 may be or include tangible, non-transient volatile memory or non-volatile memory. For instance, the memory 116 may include database components, object code components, script components, or any other type of information structure for supporting the various activities and information structures described herein.

The communications interface 112 may include any combination of wired and/or wireless interfaces (e.g., jacks, antennas, transmitters, receivers, transceivers, wire terminals) for conducting data communications with various systems or devices of the robot 100. For instance, the communications interface 112 can enable communications between the processing circuitry 110 (or the processor 114) and the actuators 118, sensors, or cameras integrated into the robot 100. In some implementations, the communications interface 112 can enable communications with remote systems or devices.

The processing circuitry 110 or the processor 114 can be configured to control the joints of the robot 100. The processing circuitry 110 or the processor 114 can control a joint or movements associated with the joint by controlling the corresponding actuator(s) 118. In particular, each joint can include or can be associated with one or more actuators 118 configured to drive the motion of robot components or elements connected via the joint. As discussed in further detail below, the processing circuitry 110 or the processor 114 can send instructions to the actuator(s) 118 to cause or trigger the precise motion of one or more elements or components of the robot 100. The processing circuitry 110 or the processor 114 can control multiple joints simultaneously to achieve a coordinated movement of the robot 100.

The processing circuitry 110 or the processor 114 can receive data from sensors and/or cameras integrated in the robot 100, and make decisions, e.g., with regard to which elements of the robot 100 to move and how, based on the received data. For example, the data received from the sensors and/or cameras can be indicative of an obstacle in the path of the robot 100. The processing circuitry 110 or the processor 114 can decide to modify the path and determine the movements of one or more limbs or components of the robot 100 based on the modified path. In some implementations, the processing circuitry 110 or the processor 114 can receive data from a remote device or system indicative of a task to be performed by the robot 100, and determine a sequence of movements of the limbs or components of the robot 100 to perform the task.

While FIG. 1 shows the controller as being integrated into the chest or upper body of the robot 100, in general, the controller 108 can be placed or integrated into other regions or parts of the robot 100. For example, the robot 100 can include a head and the controller 108 can be integrated into or on the head. In some implementations, the controller 108 can be placed on the back, in or on the waist region, and/or in or on one of the limbs of the robot 100.

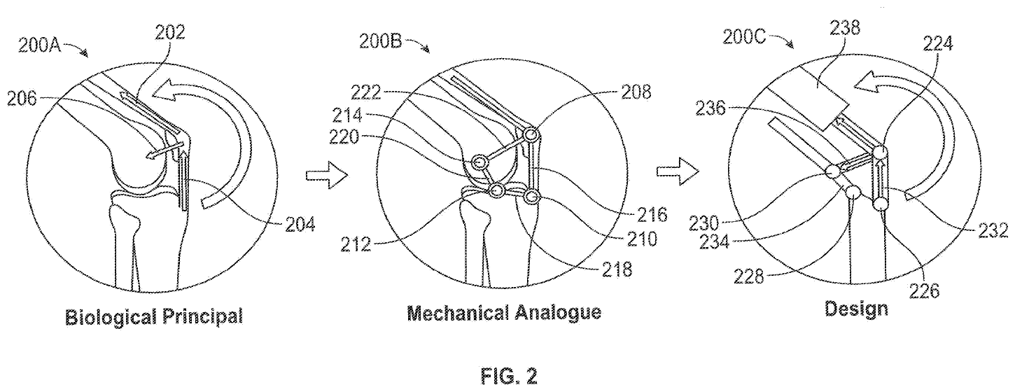

FIG. 2 illustrates diagrams 200A-C depicting an analogy between the anatomy of the human knee joint and a high-level design of a knee joint for robots, according to an embodiment. In diagram 200A, a side view of a knee anatomy is shown with arrows 202-204 depicting some of the forces applied within the knee joint. For instance, arrow 202 can be viewed as representing forces exerted by the quadriceps or quadriceps tendon on the patella. Arrow 204 can be viewed as representing forces exerted by the patella ligament on the patella. Arrow 206 can be viewed as representing forces exerted by the patella on the femur or the articular cartilage covering the end of the femur. These forces drive movements of the knee joint and maintain the structure and geometry of the knee joint. Other relevant forces include the forces between the femur and tibia along the anterior cruciate ligament (ACL) and the posterior cruciate ligament (PCL), respectively.

Diagram 200B shows an analogous mechanical system corresponding to the biological knee joint of diagram 200A. The analogous mechanical system can be viewed as a four-point or four-node mechanical system. In other words, the mechanical system can include four points or nodes 208-214 representing points of force. Point or node 208 can be viewed as corresponding to the patella. Point or node 210 can be viewed as corresponding to the connection between the patella ligament and the tibia. Point or node 212 can be viewed as corresponding to the connection between the femur and the tibia, e.g., via the ACL and/or the PCL. Point or node 214 can be viewed as a point force representing or corresponding to the force applied by the patella on the femur.

In the analogous mechanical system, the four points or nodes 208-214 can be interconnected or coupled via four links or link members. Link 216 can couple or connect points 208 and 210. Link 218 can couple or connect points 210 and 212. Link 220 can couple or connect points 212 and 214. Link 222 can couple or connect points 214 and 208.

Diagram 200C shows an example design of a knee joint assembly for robots based on the analogous mechanical system of diagram 200B. The design of the knee joint assembly can include four connection points 224-230 corresponding to the points or nodes 208-214 of the analogous mechanical system, respectively. The design can include a mechanical link or link member 232 corresponding to the link 216 of the analogous mechanical system of diagram 200B, a mechanical link or link member 234 corresponding to the link 220, and a mechanical link or link member 236 corresponding to the link 222. The connection points 226 and 228 can be arranged or implemented in a structure or component representing a lower portion of a robot's leg.

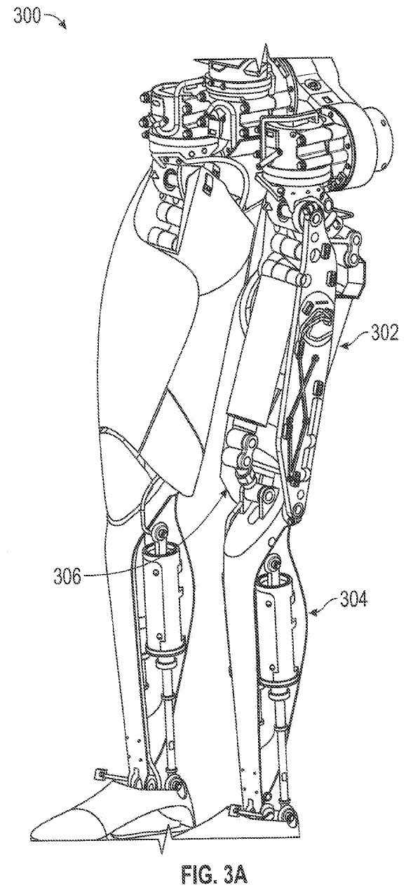

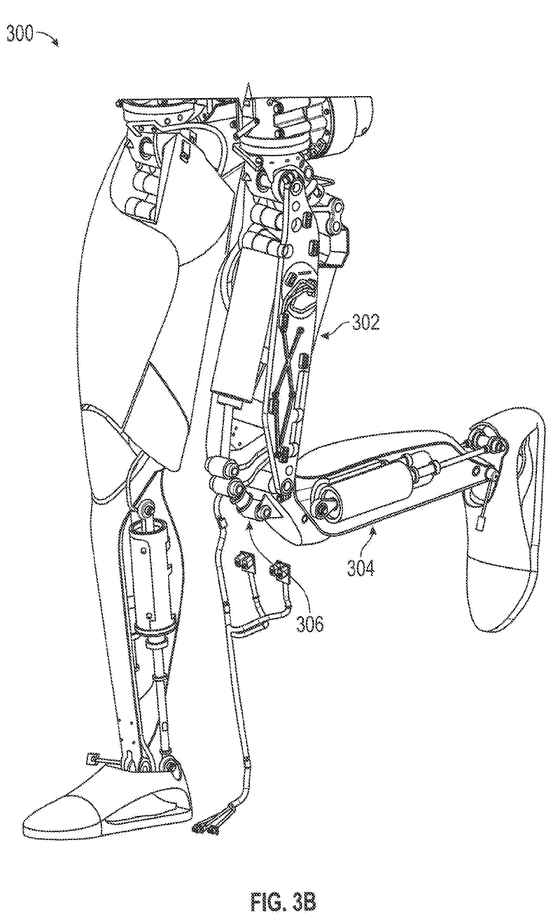

FIG. 3A illustrates a perspective view of both legs of a humanoid robot 300, according to an embodiment. Both leges of the humanoid robot 300 are in a straight-up position. Each leg can include an upper portion 302, a lower portion 304, and a knee joint assembly 306. An outer cover or housing of the upper portion 302 is removed from the left leg to expose internal components. FIG. 3B illustrates another view of the legs of the humanoid robot 300 with a different position of the lower portion, according to an embodiment.

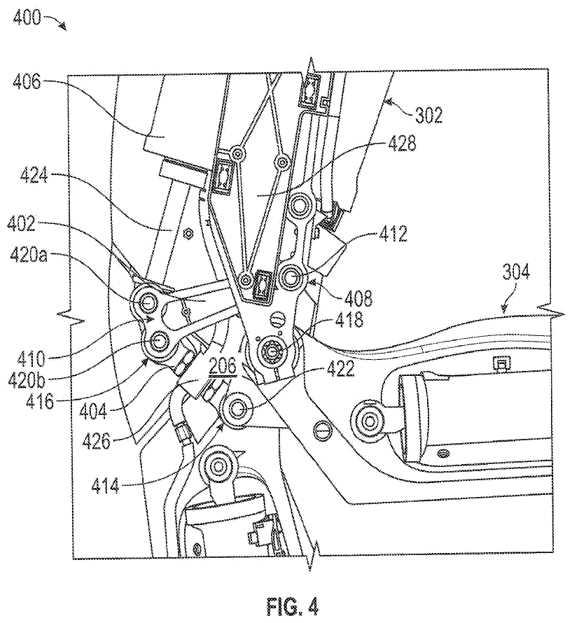

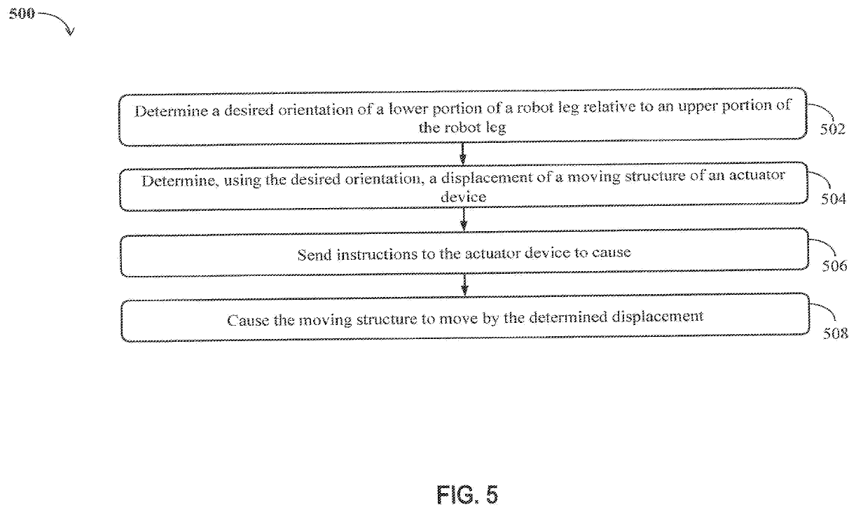

The upper portion 302 corresponds to the thigh and can be referred to herein as an upper leg, thigh portion, or upper extremity of the robot leg. The lower portion 304 corresponds to the portion of the leg between the knee and ankle and can be referred to herein as the lower extremity or lower leg. The knee joint assembly 306 can include links (or link members) and/or other components configured or structured to cause movement of the lower portion 304 relative to the upper portion 302. The knee joint assembly 306 and corresponding components and mechanisms are discussed in further detail below in relation to FIGS. 4-5.

FIG. 4 illustrates an example of knee joint assembly 400 of the humanoid robot 300 of FIG. 3, according to an embodiment. The knee joint assembly 400 can be used or integrated into humanoid robot, such as robot 100 and 300, or other types of robots. While it is referred to herein as a knee joint assembly, the joint assembly 400 can be used for other types of joints, e.g., not necessarily a knee joint. The knee joint assembly 400 can include a first link member 402 and a second link member 404. The knee joint assembly 400 can include or can be associated with a corresponding linear actuator device 406.

The first link member 402 can have a first end 408 and a second (or opposite) end 410. The first end 408 of the first link member 402 can be mechanically coupled to the upper portion 302 of the leg of the robot 300. The first link member 402 can be configured or structured to rotate around a first pivot 412 relative to the upper portion 302 of the leg of the robot 300. The second link member 404 can have a first end 414 and a second (or opposite) end 416. The first end 414 of the second link member 404 can be mechanically coupled to the lower portion 304 of the leg of the robot 300. The lower portion 304 of the leg of the robot 300 can be mechanically coupled to the upper portion 302 of the leg of the robot 304. The lower portion 304 of the leg of the robot 300 can be configured or structured to rotate around a second pivot 418 relative to the upper portion 302 of the leg of the robot 300.

The linear actuator device 406 can be mechanically coupled to the second end 408 of the first link member 402 and mechanically coupled to the second end 416 of the second link member 404. The linear actuator device 406, when actuated, can cause the first link member 402 to rotate around the first pivot 412 relative to the upper portion 402 of the leg of the robot 300. In particular, the linear actuator device 406, when actuated, can exert a force on the second end 408 of the first link member 402 causing the first link member 402 to rotate around the first pivot 412 relative to the upper portion 402 of the leg of the robot 300. The linear actuator device 406, when actuated, also causes the lower portion 302 of the leg of the robot 300 to rotate around the second pivot 418 relative to the upper portion 402 of the leg of the robot 300. In particular, the linear actuator device 406, when actuated, can exert a force on the lower portion 302 via the second link member 404 causing the lower portion 302 of the leg of the robot 300 to rotate around the second pivot 418 relative to the upper portion 402 of the leg of the robot 300.

The linear actuator device 406 can be mechanically coupled to the first link member 402 and the second link member 404 in various ways. For instance, the first link member 402 can be configured to rotate around a third pivot 420a relative to the linear actuator device 406 and the second link member 404 can be configured to rotate around a fourth pivot 420b relative to the linear actuator device 406. As shown in FIG. 4, the third pivot 420a can be different from the fourth pivot 420b. The third pivot 420a can mechanically couple the second end 408 of the first link member 402 to the linear actuator device 406 and the fourth pivot 420b can mechanically couple the second end 416 of the second link member 404 to the second end 410 of the first link member 402. In other words, the linear actuator device 406 can be directly coupled to the first link member 402 but mechanically coupled to the second link member 404 via the first link member 402.

In some implementations, the pivots 420a and 420b can be the same pivot that mechanically couples both the second end 410 of the first link member 402 and the second end 416 of the second link member 404 to the linear actuator device 406. In other words, the second end 410 of the first link member 402 can include a single pivot mechanically coupling the linear actuator device 406, the first link member 402, and the second link member 404.

In some implementations, the lower portion 304 of the leg of the robot 300 can be configured to rotate around pivot 422 relative to the second link member 404. The pivot 422 can mechanically couple the first end 414 of the second link member 404 to the lower portion 402 of the leg of the robot 300. The capability of the lower portion 304 of the leg of the robot 300 to rotate around the pivot 422 and relative to the second link member 404 implies flexibility in the angle between the lower portion 304 of the leg of the robot 300 and the second link member 404.

The linear actuator device 406 can include a moving structure 424, such as a rod or shaft among others. The moving structure 424 can be mechanically coupled to the second end 410 of the first link member 402. When the linear actuator device 406 is actuated, the moving structure 424 moves according to a translational motion and exerts some force on the second end 410 of the first link member 402 causing the second end 410 of the first link member 402 to move, e.g., according to the translational motion. The movement of the second end 410 results in the first link member 402 rotating around the first pivot 412 relative to the upper portion 302 of the leg of the robot 300.

The linear actuator device 406 can include a servo motor configured to cause the moving structure 424 to move according to the translational motion. A servo motor can allow for precise displacements or displacement increments of the moving structure 424 of the linear actuator device 406. Each displacement increment can correspond to an increment in the angle between the upper portion 302 and the lower portion 304 of the leg of the robot 300.

Comparing the knee joint assembly 400 of FIG. 4 to the analogous mechanical system and joint design of FIG. 2, the pivots 420a and 420b can be viewed as corresponding to point 208 and connection point 224 of FIG. 2. Pivot 422 can be viewed as corresponding to point 210 or connection point 226 of FIG. 2. Pivot 412 can be viewed as corresponding to point 214 or connection point 230, and pivot 418 can be viewed as corresponding to point 212 or connection point 228 of FIG. 2. Also, the first link member 402 can be viewed as corresponding to links 222 and 236 of FIG. 2 and the second link member 404 can be viewed as corresponding to links 216 and 232 of FIG. 2.

The knee joint assembly 400 enables or allows the use of a relatively simple and relatively small actuator, such as the linear actuator 406. In other words, the design of the knee joint assembly 400 allows for linear motion produced by the linear actuator device 406 to be translated into a rotational motion of the lower portion 304 of the leg of the robot 300 relative to the upper portion 302. The lower portion 304 of the leg of the robot 300 can have a rotation angle range of about 180 degrees. For example, the robot 300 can bend or move the lower portion 304 of the leg backward all the way up to 180 degrees or to an angle close to but smaller than 180 degrees, such as 175 or 170 degrees.

The knee joint assembly 400 enables such a wide range of rotational motion of the lower portion 304 without going into poor geometry and with a relatively high efficiency. For example, while the rotation angle range of the lower portion 304 of the leg is about 180 degrees, the corresponding rotation angle range of the first link member 402 on which the linear actuator device 406 exerts force can be about 60 degrees (e.g., between 50 to 70 degrees or between 45 to 75 degrees). In other words, to make the lower portion 302 rotate by about 180 degrees, the linear actuator device 406 can push or exert a force on the second end 410 of the first link member 402 to cause the first link member 402 to rotate by only about 60 degrees around the pivot 412. This means that the moving structure 424 of the linear actuator device 406 is moved, in a linear motion, by a relatively small distance or displacement.

In some implementations, the second link member 404 can include a force sensor 426, for example, to measure forces on the second link member 404. The force sensor 426 can be communicatively coupled to the controller 108 or the processing circuitry 410. In some implementations, the first link member 402 can be mechanically coupled to a structure 428 of the upper portion 402 via the pivot 412. can be a humanoid robot. The linear actuator device 406 can installed or integrated in the upper portion 402 of the leg of the robot 300.

The controller 108 or the processing circuitry 110 can control the linear actuator device 406. For instance, the processing circuitry 110 or processor 114 can specify the amount of displacement or movement to be made by the moving structure 424 at any time instance. The mechanism of operating the knee joint assembly 400 is described in more detail below in relation with FIG. 5.

FIG. 5 illustrates a flow chart depicting a method 500 for operating or controlling the knee joint assembly 400 of FIG. 4, according to an embodiment. In brief overview, the method 500 can include determining a desired orientation of the lower portion 304 of a robot leg relative to an upper portion 302 of the robot leg (STEP 502), and determining, using the desired orientation, a displacement of the moving structure 424 of the linear actuator device 406 (STEP 504). The method 500 can include sending or transmitting instructions to the linear actuator device 406 to cause the moving structure to move by the determined displacement (STEP 506), and causing, by the linear actuator device 406, the moving structure 424 to move by the determined displacement leading to a rotation of the lower portion 304 of the robot leg relative to the upper portion 302 of the robot leg to reach the desired orientation (STEP 508).

The method 500 can be performed or executed by the processing circuitry 110 or the processor 114 in combination with the linear actuator device 406. The processing circuitry 110 or the processor 114 can execute computer code instructions, e.g., stored in memory 116, to perm steps 502-506 of method 500.

The method 500 can include the processing circuitry 110 or processor 114 determining a desired orientation of the lower portion 304 of the robot leg relative to an upper portion of the robot leg (STEP 502). In particular, the processing circuitry 110 or processor 114 can determine a desired angle between the lower portion 304 of the robot leg relative to the upper portion 302 of the robot leg. The processing circuitry 110 or processor 114 can determine the desired angle or orientation based on or as part of a desired task (e.g., walking, jumping, kicking a ball, etc.) to be performed by the robot. The processing circuitry 110 or processor 114 can break the task into a sequence of movements to be performed over a period of time. In some implementations, the processing circuitry 110 or processor 114 can determine an instantaneous position or orientation of the lower portion 304 of the robot leg relative to an upper portion of the robot leg, a speed of the lower portion 304 of the robot leg and a desired torque. The processing circuitry 110 or processor 114 can use a function mapping actuator force to joint torque and/or a function from linkage force sensor to joint torque.

The method 500 can include the processing circuitry 110 or processor 114 determining, using the desired orientation, a displacement of the moving structure 424 of the linear actuator device 406 (STEP 504). Given the geometry and design of the knee joint assembly 400, each angle between the lower portion 304 of the robot leg and the upper portion 302 of the robot leg corresponds or maps to a corresponding position of the moving structure 424 (or a corresponding state of the linear actuator device 406). In other words, the lower portion 304 of the robot leg is positioned or oriented at a given angle relative to the upper portion 302 when the moving structure 424 is at a corresponding specific displacement or position. The processing circuitry 110 or processor 114 can maintain a data structure, e.g., in memory 116, storing mappings or associations between various values of the angle between the lower portion 304 of the robot leg and the upper portion 302 of the robot leg and corresponding positions or displacement values of the moving structure 424 (or corresponding states of the linear actuator device 406). The processing circuitry 110 or processor 114 can determine a desired position or displacement of the moving structure 424 using the data structure and the desired orientation or angle of the lower portion 302 of the robot leg.

In some implementations, the processing circuitry 110 or processor 114 can compute the desired position or displacement of the moving structure 424 in real time, e.g., using closed form expressions or formulas for force, torque and/or speed. The processing circuitry 110 or processor 114 can use the instantaneous position the lower portion 304 of the robot leg (e.g., angle between the lower portion 304 of the robot leg and the upper portion 302), the speed of the lower portion 304 and/or the desired torque to determine the position or displacement of the moving structure 424 in real time.

In some implementations, the processing circuitry 110 or processor 114 can keep track of a current angle between the lower portion 304 of the robot leg relative to the upper portion of the robot leg as well as a current state of the linear actuator device 406 or a current position of the moving structure 424. The processing circuitry 110 or processor 114 can determine an additional displacement or movement to be made by the moving structure 424 using the data structure, the desired and current orientations of the lower part as well as the current position of the moving structure 424.

The method 500 can include the processing circuitry 110 or processor 114 sending or transmitting instructions to the linear actuator device 406 to cause the moving structure to move by the determined displacement (STEP 506), and the linear actuator device 406 causing the moving structure 424 to move by the determined displacement leading to a rotation of the lower portion 304 of the robot leg relative to the upper portion 302 of the robot leg to reach the desired orientation (STEP 508). The processing circuitry 110 or processor 114 can send or transmit the instructions to the linear actuator device 406 via the communications interface 112. The instructions can include an indication of a new or desired state of the linear actuator device 406, an indication of a new position of the moving structure 424, or an indication of a direction and distance according to which to move moving structure 424.

In some implementations, parameters of the knee joint design described herein, e.g., the lengths of the first link member 402 and a second link member 404, can be selected or determined, e.g., via computer simulations, in a way to minimize or reduce power usage by the actuator 406. Given a trajectory of the knee joint to perform a specific task, e.g., walking or running, a computer system including one or more processors and a memory can simulate the knee joint assembly 400 with different parameters and determine the set of parameters leading to the least consumed power by the actuator 406. The trajectory of the knee joint can include the position or angle (e.g., of the lower portion 304 of the robot leg), speed and linkage joint torque over time to achieve the specific task.

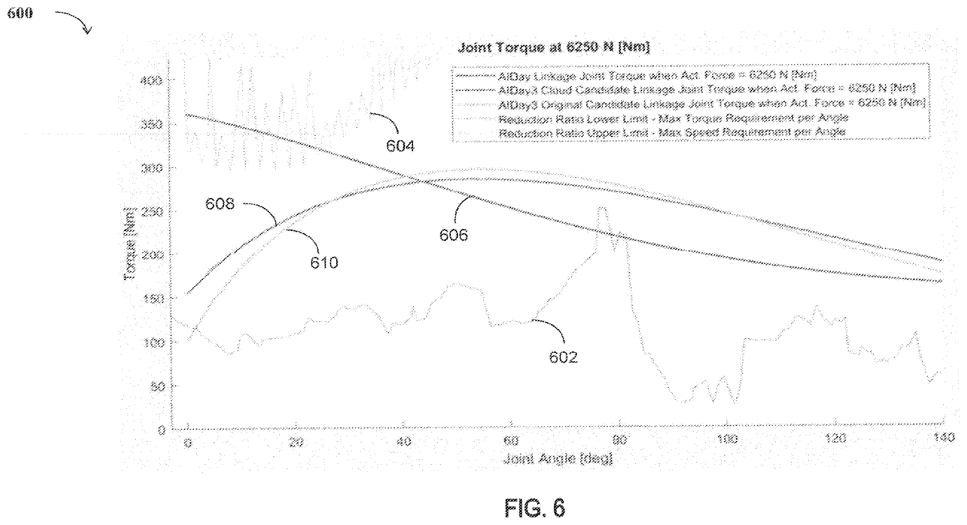

Referring to FIG. 6, a graph 600 showing simulation results for different candidate designs (e.g., with different parameters) of the knee joint assembly 400 is illustrated, according to an embodiment. The x-axis shows the joint angle or position, e.g., angle of the lower portion 304 of the robot leg. The plots 602 and 604 represent the speed and linkage joint torque over time to achieve the specific task. The plots 606-610 represent the linkage joint torque for three different designs (e.g., with different parameters) of the knee joint assembly 400 determined by computer simulations. A computer system can determine the power used be the actuator 406 (e.g., using simulation data) for each design, and compare the determined power values. The design with the lowest power usage can be selected as the final model or design for the knee joint assembly 400. In other words, before building or manufacturing the knee joint assembly 400, the computer system can determine the desired parameters (e.g., of the lower portion 304 of the robot leg) to be used.

While FIG. 6 shows three candidate designs, the computer system can simulate a larger number of designs to optimize or determine the “best” set of parameter values in terms of reducing or minimizing power usage. In some implementations, the simulations can be iterative where the set of parameters are modified in each new simulation based on results of previous simulations.

In response to the received instructions, a controller of the linear actuator device 106 can actuate the motor, e.g., servo motor, to cause the moving structure to be moved or displaced by the determined displacement or to the new position.

While embodiments described herein are discussed in relation with a knee joint assembly of a humanoid robot, the embodiments can be used or applied in other types of joints and/or other types of robots.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or a machine-executable instruction may represent a procedure, function, subprogram, program, routine, subroutine, module, software package, class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code, it being understood that software and control hardware can be designed to implement the systems and methods based on the description herein.

When implemented in software, the functions may be stored as one or more instructions or code on a non-transitory, computer-readable, or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitates the transfer of a computer program from one place to another. A non-transitory, processor-readable storage media may be any available media that can be accessed by a computer. By way of example, and not limitation, such non-transitory, processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that can be accessed by a computer or processor. Disk and disc, as used herein, include compact disc (CD), laser disc, optical disc, digital versatile disc (DVD), Blu-ray disc, and floppy disk, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory, processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A system comprising:
a knee joint assembly including:
a first link member having a first end mechanically coupled to an upper portion of a leg of a robot and configured to rotate around a first pivot relative to the upper portion of the leg of the robot;
a second link member having a first end mechanically coupled to a lower portion of the leg of the robot, the lower portion of the leg of the robot mechanically coupled to the upper portion of the leg of the robot and configured to rotate around a second pivot relative to the upper portion of the robot; and
a linear actuator device mechanically coupled to a second end of the first link member and a second end of the second link member, the linear actuator device, when actuated, causes the first link member to rotate around the first pivot relative to the upper portion of the leg of the robot and causes the lower portion of the leg of the robot to rotate around the second pivot relative to the upper portion of the leg of the robot.

2. The system of claim 1, wherein the first link member is configured to rotate around a third pivot relative to the linear actuator device and the second link member is configured to rotate around a fourth pivot relative to the linear actuator device.

3. The system of claim 2, wherein the fourth pivot is the same as the third pivot, and the third pivot mechanically couples both the second end of the first link member and the second end of the second link member to the linear actuator device.

4. The system of claim 2, wherein the fourth pivot is different from the third pivot, the third pivot mechanically couples the second end of the first link member to the linear actuator device, and the fourth pivot mechanically couples the second end of the second link member to the second end of the first link member.

5. The system of claim 1, wherein the lower portion of the leg of the robot is configured to rotate around a third pivot relative to the second link member, the third pivot mechanically coupling the first end of the second link member to the lower portion of the leg of the robot.

6. The system of claim 1, wherein the linear actuator device includes a moving structure mechanically coupled to the second end of the first link member and configured to cause the second end of the first link member to move according to a translational motion, when the linear actuator device is actuated, causing the first link member to rotate around the first pivot relative to the upper portion of the leg of the robot.

7. The system of claim 6, wherein the linear actuator device includes a servo motor configured to cause the moving structure to move according to the translational motion.

8. The system of claim 1, wherein the first link member has a rotation angle range of about 60 degrees.

9. The system claim 1, wherein the lower portion of the leg of the robot has a rotation angle range of about 150 degrees.

10. The system claim 1, wherein the second link member includes a force sensor.

11. The system claim 1, further comprising a processing circuitry including a memory and a processor and configured to control the linear actuator device.

12. The system claim 11, wherein the processing circuitry is configured to:
determine a desired orientation of the lower portion of the leg of the robot relative to the upper portion of the leg of the robot;
determine, using the desired orientation of the lower portion of the leg of the robot relative to the upper portion of the leg of the robot, a displacement of a moving structure of the linear actuator device; and
send instructions to the linear actuator device to cause the moving structure to move by the determined displacement.

13. The system claim 12, wherein the processing circuitry is configured to compute the displacement of the moving structure in real time using an instantaneous orientation of the lower portion of the leg of the robot, a speed of the lower portion of the leg of the robot and a desired torque.

14. The system claim 1, wherein the robot is a humanoid robot.

15. A method comprising:
determining, by a processing circuitry, an orientation of a lower portion of a leg of a robot relative to an upper portion of the leg of the robot, the lower portion of the leg of the robot mechanically coupled to the upper portion of the leg of the robot and configured to rotate around a first pivot relative to the upper portion of the robot;
determining, by the processing circuitry using the orientation of the lower portion of the leg of the robot relative to the upper portion of the leg of the robot, a displacement of a moving structure of a linear actuator device, the moving structure of the linear actuator device mechanically coupled to a first end of the first link member and a first end of the second link member;
sending instructions to the linear actuator device to cause the moving structure to move by the determined displacement; and
causing, by the linear actuator device, the moving structure to move by the determined displacement leading to a rotation of the lower portion of the leg of the robot relative to the upper portion of the leg of the robot to reach the desired orientation,
the first link member having a second end mechanically coupled to the upper portion of the leg of the robot and configured to rotate around a second pivot relative to the upper portion of the leg of the robot, and the second link member having a second end mechanically coupled to the lower portion of the leg of the robot.

16. The method of claim 15, wherein determining the displacement of the moving structure includes computing the displacement of the moving structure in real time using an instantaneous orientation of the lower portion of the leg of the robot, a speed of the lower portion of the leg of the robot and a desired torque.

17. The method of claim 15, wherein the first link member is configured to rotate around a third pivot relative to the moving structure of the linear actuator device and the second link member is configured to rotate around a fourth pivot relative to the moving structure of the linear actuator device.

18. The method of claim 17, wherein the fourth pivot is the same as the third pivot, and the third pivot mechanically couples both the second end of the first link member and the second end of the second link member to the linear actuator device; or
the fourth pivot is different from the third pivot, the third pivot mechanically couples the second end of the first link member to the linear actuator device, and the fourth pivot mechanically couples the second end of the second link member to the second end of the first link member.

19. The method of claim 15, wherein the lower portion of the leg of the robot is configured to rotate around a third pivot relative to the second link member, the third pivot mechanically coupling the first end of the second link member to the lower portion of the leg of the robot.

20. The method of claim 16, wherein the first link member has a rotation angle range of about 60 degrees and the lower portion of the leg of the robot has a rotation angle range of about 150 degrees.
